(19) United States
(12) Patent Application Publication
(10) Pub. No.: US 2016/0309086 A1
(43) Pub. Date: Oct. 20, 2016

(54) ELECTRONIC DEVICE AND METHOD

(71) Applicant: KABUSHIKI KAISHA TOSHIBA, Tokyo (JP)

(72) Inventors: Mitsuhiro KIMURA, Tokyo (JP); Kaoru Matsuoka, Tokyo (JP)

(73) Assignee: KABUSHIKI KAISHA TOSHIBA, Tokyo (JP)

(21) Appl. No.: 14/932,234

(22) Filed: Nov. 4, 2015

Related U.S. Application Data
(60) Provisional application No. 62/147,445, filed on Apr. 14, 2015.

(51) Int. Cl. H04N 5/232; G06T 5/00; G06T 5/20; G06T 3/40

(52) U.S. Cl. CPC H04N 5/23238; G06T 3/4038; G06T 5/006; G06T 5/20

(57) ABSTRACT

According to one embodiment, an electronic device includes a memory and a circuitry coupled to the memory. The circuitry is configured to acquire a first image and a second image partly overlapping each other. The circuitry is configured to correct the first image if a slope of a subject in the second image is more similar to a predetermined value than a slope of the subject in the first image, a slope of the subject in the corrected first image being equal to the slope of the object in the second image. The circuitry is configured to generate a third image by stitching the corrected first image to the second image. The circuitry is configured to display the third image on a display.

### CROSS-REFERENCE TO RELATED APPLICATIONS

This application claims the benefit of U.S. Provisional Application No. 62/147,445, filed Apr. 14, 2015, the entire contents of which are incorporated herein by reference.

### FIELD

Embodiments described herein relate generally to an electronic device and a method.

### BACKGROUND

Recently, electronic devices having a panoramic photography function and capable of photographing a subject over a wide range have become widespread. The panoramic photography function is a function of capturing a plurality of images while the electronic device is panning in accordance with the movement of the user, and generating an image (or video) (hereinafter referred to as a panoramic image) based on the captured images (or videos).

The panoramic photography function is generally accompanied by a preview display function of stitching one or more previously-captured images without any change every time an image is captured, and displaying the stitched image on the screen of the electronic device. According to the preview display function, the user can perform (forward) photography while checking images that have been captured until now.

If the subject is a plane rectangular object (for example, a blackboard), according to the panoramic photography function, images of the subject include images obtained by photographing the subject from the oblique direction. If the images captured from the oblique direction are stitched to other images without any change and displayed for preview on the screen of the electronic device, there is a problem that the user cannot easily understand how far the subject has been photographed and whether enough images to generate a panoramic image have been captured.

Therefore, the realization of new technology to solve the above problem is needed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an appearance of an electronic device according to an embodiment.

FIG. 2 is a diagram showing an example of a system configuration of a tablet computer.

FIG. 3 is an illustration of a degree of image deformation caused by an angle between an imaging device and a subject.

FIG. 4 is another illustration of the degree of image deformation caused by an angle between the imaging device and the subject.

FIG. 5 is an illustration of a general preview display function.

FIG. 6 is a block diagram showing an example of a functional structure of a panoramic photography application program according to the embodiment.

FIG. 7 is a flowchart showing an example of a process executed in an image movement amount calculator.

FIG. 8 is a flowchart showing an example of a process executed in a display evaluation value calculator.

FIG. 9 is an illustration of upper and lower borders of a subject detected in the display evaluation value calculator.

FIG. 10 is a flowchart showing an example of a process executed in a deformation module.

FIG. 11 is a flowchart showing an example of a process executed in an image stitching module.

FIG. 12 is a flowchart showing an example of a series of processes executed in the panoramic photography application program.

FIG. 13 is an illustration of an effect achieved by including the panoramic photography application program.

FIG. 14 is a table for illustrating the effect achieved by including the panoramic photography application program.

FIG. 15 is an illustration of an example of a screen displayed during a process of panoramic photography.

### DETAILED DESCRIPTION

Various embodiments will be described hereinafter with reference to the accompanying drawings.

In general, according to one embodiment, an electronic device includes a memory and a circuitry coupled to the memory. The circuitry is configured to acquire a first image and a second image partly overlapping each other. The circuitry is configured to correct the first image if a slope of a subject in the second image is more similar to a predetermined value than a slope of the subject in the first image, a slope of the subject in the corrected first image being equal to the slope of the object in the second image. The circuitry is configured to generate a third image by stitching the corrected first image to the second image. The circuitry is configured to display the third image on a display.

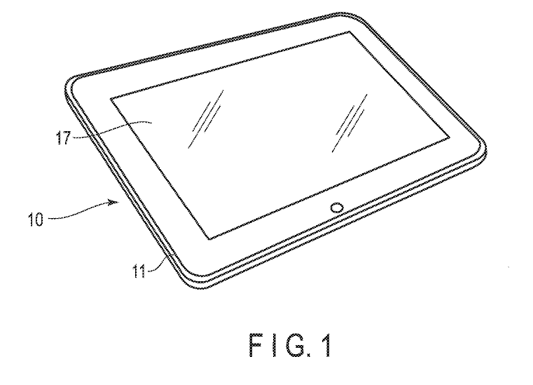

FIG. 1 is a perspective view showing an example of an appearance of an electronic device according to an embodiment. The electronic device is, for example, a portable electronic device including a camera (imaging device). The electronic device may be implemented as a tablet computer, a notebook personal computer, a smartphone, a PDA or the like. A tablet computer 10 is also called a tablet or a slate computer. A body 11 of the tablet computer 10 has a thin box-shaped housing.

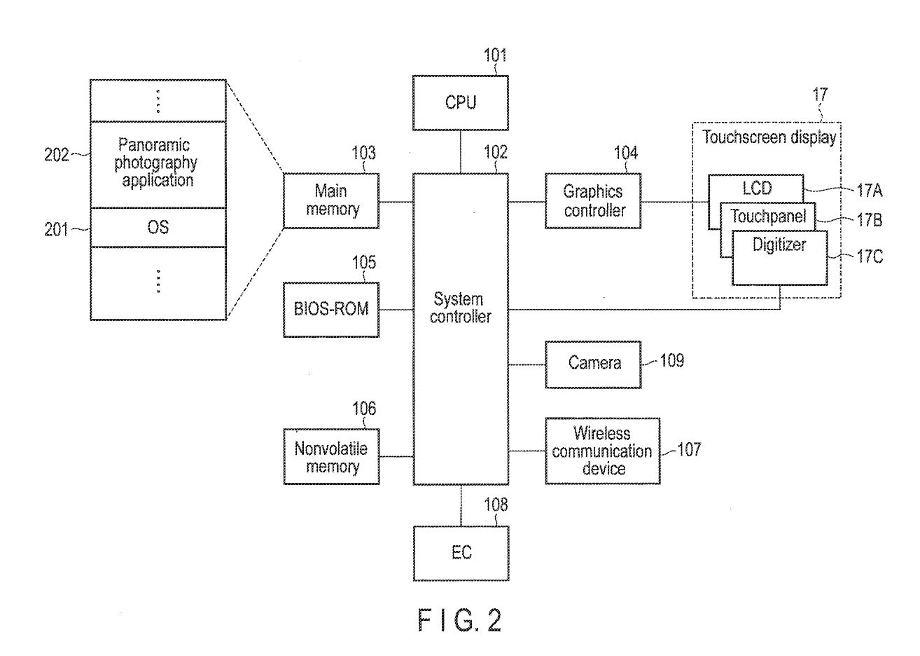

A touchscreen display (hereinafter referred to as a display) 17 is attached to the body 11 to overlap the top surface of the body 11. A flat panel display and a sensor configured to detect the contact position of a pen or a finger on the screen of the flat panel display are incorporated into the display 17. For example, the flat panel display may be a liquid crystal display (LCD). As the sensor, for example, a capacitance type touchpanel and an electromagnetic induction type digitizer may be used. In FIG. 2, it is assumed that two types of sensors, i.e., the digitizer and the touchpanel are incorporated into the display 17.

FIG. 2 is a diagram showing an example of a system configuration of the tablet computer 10.

The tablet computer 10 includes a CPU 101, a system controller 102, a main memory 103, a graphics controller 104, a BIOS-ROM 105, a nonvolatile memory 106, a wireless communication device 107, an embedded controller (EC) 108, a camera 109 and the like.

The CPU 101 is a processor which controls operations of various modules in the tablet computer 10. The processor is constituted by at least a processing circuit. The CPU 101 executes various types of software loaded from the nonvolatile memory 106 serving as a storage device into the main memory 103. The software includes an operating system (OS) 201 and various application programs. The application programs include a panoramic photography application program 202. The panoramic photography application program 202 is an application program that operates in combination with the camera 109 and has, for example, a panoramic photography function of photographing a subject (object to be photographed) over a wide range. The panoramic photography function is a function of capturing a plurality of images while the tablet computer 10 including the camera 109 is panning in accordance with the movement of the user, and generating a panoramic image based on the captured images (or videos). The panoramic photography application program 202 also has a preview display function of displaying, on the display 17, one or more previously-captured images every time an image is captured, in association with the panoramic photography function.

The CPU 101 also executes a basic input/output system (BIOS) stored in the BIOS-ROM 105. The BIOS is a program for hardware control.

The system controller 102 is a device which connects a local bus of the CPU 101 with various components and modules. The system controller 102 is equipped with a memory controller which executes access control of the main memory 103. The system controller 102 also has a function of communicating with the graphics controller 104 via, for example, a serial bus conforming to the PCI EXPRESS standard.

The graphics controller 104 is a display controller which controls an LCD 17A used as a display monitor of the tablet computer 10. A display signal generated by the graphics controller 104 is transmitted to the LCD 17A. The LCD 17A displays a screen image based on the display signal. The LCD 17A, a touchpanel 17B and a digitizer 17C overlap one another. The touchpanel 17B is a capacitance type pointing device to execute input on the screen of the LCD 17A. The contact position, the movement of the contact position, etc., of the finger on the screen are detected by the touchpanel 17B. The digitizer 17C is an electromagnetic induction type pointing device to execute input on the screen of the LCD 17A. The contact position, the movement of the contact position, etc., of the pen on the screen are detected by the digitizer 17C.

The wireless communication device 107 is a device configured to execute wireless communication such as wireless LAN or 3G mobile communication. The EC 108 is a one-chip microcomputer including an embedded controller for power management. The EC 108 has a function of powering on or off the tablet computer 10 in accordance with a power button operation by the user. The camera 109 is an imaging device.

The same function as the function implemented by the CPU 101 executing the panoramic photography application program 202 may be implemented by a dedicated hardware circuit. The tablet computer 10 may include the dedicated hardware circuit.

The preview display function is briefly described. The preview display function is a function of displaying one or more images that have been captured until now when capturing a panoramic image. According to the preview display function, the user can forward photography while checking the images that have been captured until now.

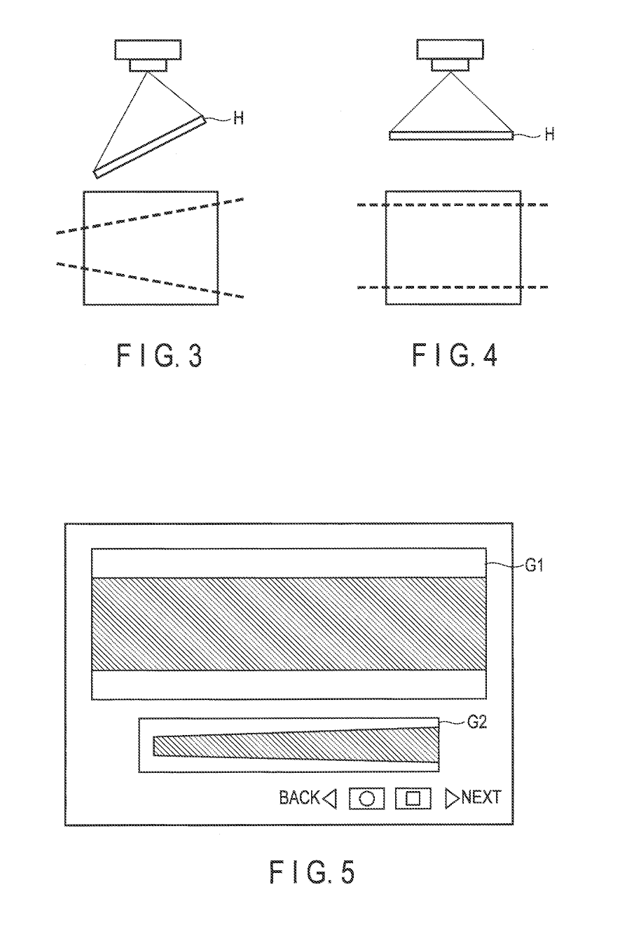

If a subject H to be photographed in a panoramic image is a plane rectangular object (for example, a blackboard) as shown in FIG. 3, however, the subject H is often photographed from the oblique direction because the camera captures images while panning. In this case, upper and lower sides of the subject H are obliquely deformed in an image obtained as a result of the photography, as shown in FIG. 3.

When photography is forwarded while panning the camera, there is also a case where the subject H is photographed from the front. In this case, upper and lower sides of the subject H are not deformed, i.e., not distorted in an image obtained as a result of the photography, as shown in FIG. 4.

In the preview display function, a method of stitching images obtained as a result of the photography in accordance with a slope of an image captured before the images and displaying the stitched image is also considered. According to the method, however, an image largely different from a video displayed on a photography screen G1 is displayed on a preview display screen G2 as shown in FIG. 5 if the newest captured image is not distorted but the image captured before the newest image is distorted, which causes a problem that the user cannot easily understand how far the subject H has been photographed and whether enough images to generate a panoramic image have been captured.

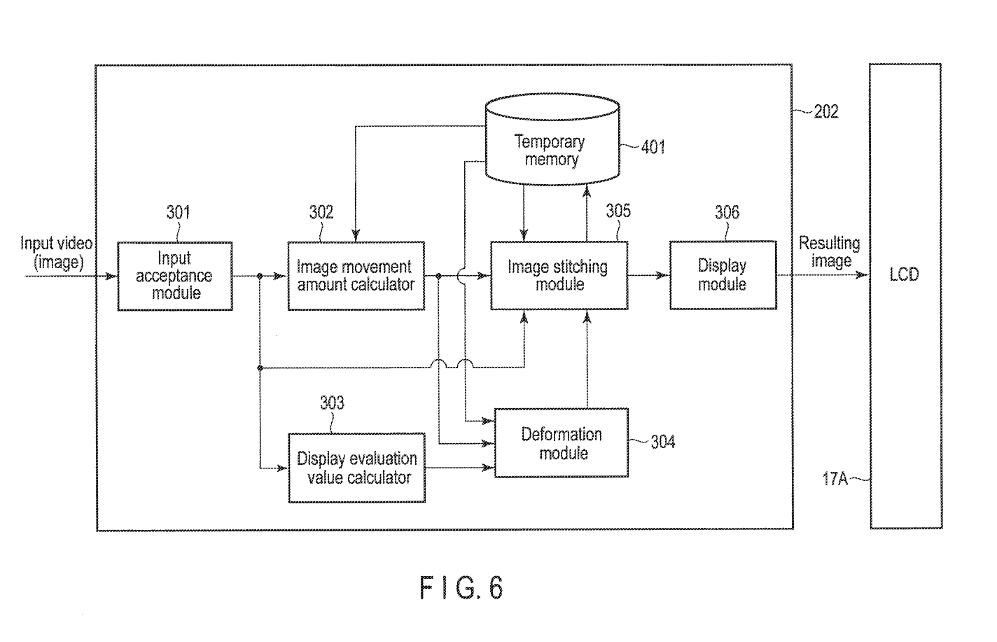

The panoramic photography application program 202 of the present embodiment has a function that can solve the above problem. A functional structure of the panoramic photography application program 202 is hereinafter described in detail with reference to FIG. 6.

FIG. 6 is a block diagram showing an example of the functional structure of the panoramic photography application program 202. As shown in FIG. 6, the panoramic photography application program 202 includes an input acceptance module 301, an image movement amount calculator 302, a display evaluation value calculator 303, a deformation module 304, an image stitching module 305, a display module 306, a temporary memory 401 and the like.

It is hereinafter assumed that an object to be photographed by the camera 109 provided in the tablet computer 10 is a plane rectangular object having a width beyond a photographable range that the camera 109 can capture at a time and a height within the photographable range.

The input acceptance module 301 accepts input of an image captured by the camera 109 (in other words, acquires an image captured by the camera 109). It is assumed that images continuously captured and having portions overlapping each other are sequentially input to the input acceptance module 301. The input images are sequentially transmitted to the image movement amount calculator 302, the display evaluation value calculator 303 and the image stitching module 305. In the description below, an image input at time t (in other words, an image captured at time t) is referred to as an image P(t).

The image movement amount calculator 302 calculates an image movement amount based on the images transmitted from the input acceptance module 301. More specifically, based on an image P(t) transmitted from the input acceptance module 301 and an accumulated image Accum(t−1) stored in the temporary memory 401, the image movement amount calculator 302 calculates an image movement amount indicating how far the camera 109 has moved from time t−1 to time t (in other words, an image movement amount indicating how the image P(t) and the accumulated image Accum(t−1) overlap each other). The accumulated image Accum(t−1) is a group of images that have been captured until just before the image P(t), i.e., an image displayed for preview on the LCD 17A.

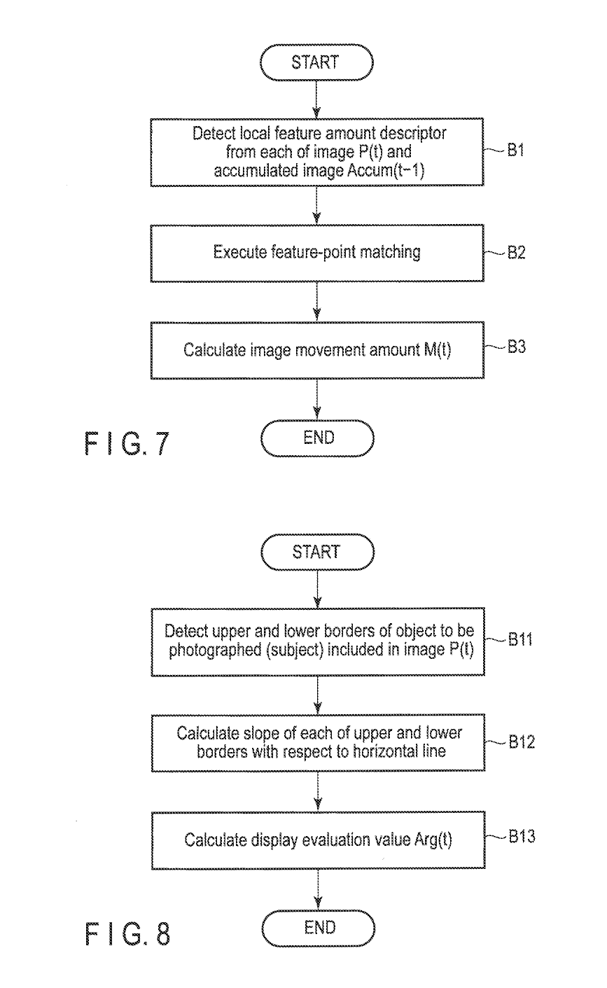

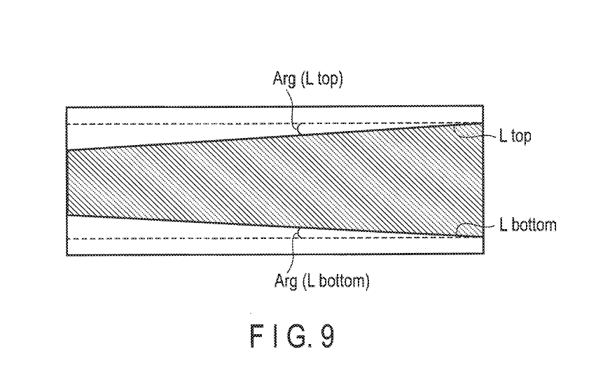

An example of an image movement amount calculation process executed by the image movement amount calculator 302 to calculate the image movement amount is described with reference to a flowchart of FIG. 7.

First, the image movement amount calculator 302 detects a local feature amount descriptor from each of the image P(t) and the accumulated image Accum(t−1) (block B1). A local feature amount is a feature amount that can be constantly detected in a similar local region even if the local region in the image is rotated, or enlarged or reduced (i.e., transformed in scale).

After detecting the local feature amount descriptor from each of the image P(t) and the accumulated image Accum(t−1), the image movement amount calculator 302 executes processing of associating coordinates of a point at which the local feature amount is present in the image P(t) with those in the image Accum(t−1) (in other words, processing for finding a pair of feature points or feature-point matching), based on the detected local feature amount descriptors by using, for example, a random sample consensus (RANSAC) method (block B2).

After that, the image movement amount calculator 302 calculates an image movement amount M(t) indicating how far the camera 109 has moved from time t−1 to time t based on the pair of associated feature points by using Hamming distances in a round-robin fashion (block B3).

The process of blocks B1 to B3 is executed every time an image is captured by the camera 109.

In the present embodiment, the image movement amount M(t) is calculated in the process of blocks B1 to B3. However, the method of calculating the image movement amount M(t) is not limited to this, and the image movement amount M(t) may be calculated in another method.

The description returns to FIG. 6. The display evaluation value calculator 303 calculates a display evaluation value of the image P(t) based on the image P(t) transmitted from the input acceptance module 301. More specifically, the display evaluation value calculator 303 calculates a display evaluation value indicating how much a projection plane (imaging plane) of the image P(t) transmitted from the input acceptance module 301 is suitable for preview display (in other words, indicating a degree of inclination of the oblique direction from which the image P(t) is captured).

An example of a display evaluation value calculation process executed by the display evaluation value calculator 303 to calculate the display evaluation value is described with reference to a flowchart of FIG. 8.

First, the display evaluation value calculator 303 detects upper and lower borders of the object to be photographed (subject) included in the image P(t) (block B11). The upper and lower borders are an upper side Ltop and a lower side Lbottom of the plane rectangular object to be photographed.

After detecting the upper and lower borders from the image P(t), the display evaluation value calculator 303 calculates a slope of each of the detected upper and lower borders with respect to a horizontal line (block B12). More specifically, the display evaluation value calculator 303 calculates a slope Arg(Ltop) of the upper side Ltop of the plane rectangular object to be photographed with respect to the horizontal line and a slope Arg(Lbottom) of the lower side Lbottom of the plane rectangular object with respect to the horizontal line.

After that, the display evaluation value calculator 303 compares absolute values of the two calculated slopes Arg(Ltop) and Arg(Lbottom) and calculates the smaller value as a display evaluation value Arg(t) of the image P(t) (block B13).

Since the slopes of the upper side Ltop and the lower side Lbottom of the plane rectangular object included in the image P(t) with respect to the horizontal line become smaller as the plane rectangular object faces the front of the camera 109, the display evaluation value Arg(t) also becomes smaller as the plane rectangular object faces the front of the camera 109.

The process of blocks B11 to B13 is executed every time an image is captured by the camera 109.

The description returns to FIG. 6. The deformation module 304 determines whether to execute projective transformation of the accumulated image Accum(t−1) stored in the temporary memory 401, based on the display evaluation value Arg(t) of the image P(t) calculated by the display evaluation value calculator 303. As a result, if the deformation module 304 determines that projective transformation should be executed, the deformation module 304 executes projective transformation of the accumulated image Accum(t−1) by using the image movement amount M(t) calculated by the image movement amount calculator 302 and transmits a new accumulated image Accum(t−1)′ obtained as a result of the projective transformation to the image stitching module 305. The new accumulated image Accum(t−1)′ is arbitrarily stored in the temporary memory 401. In contrast, if the deformation module 304 determines that the projective transformation should not be executed, the deformation module 304 copies the accumulated image Accum(t−1) and transmits the copied image to the image stitching module 305.

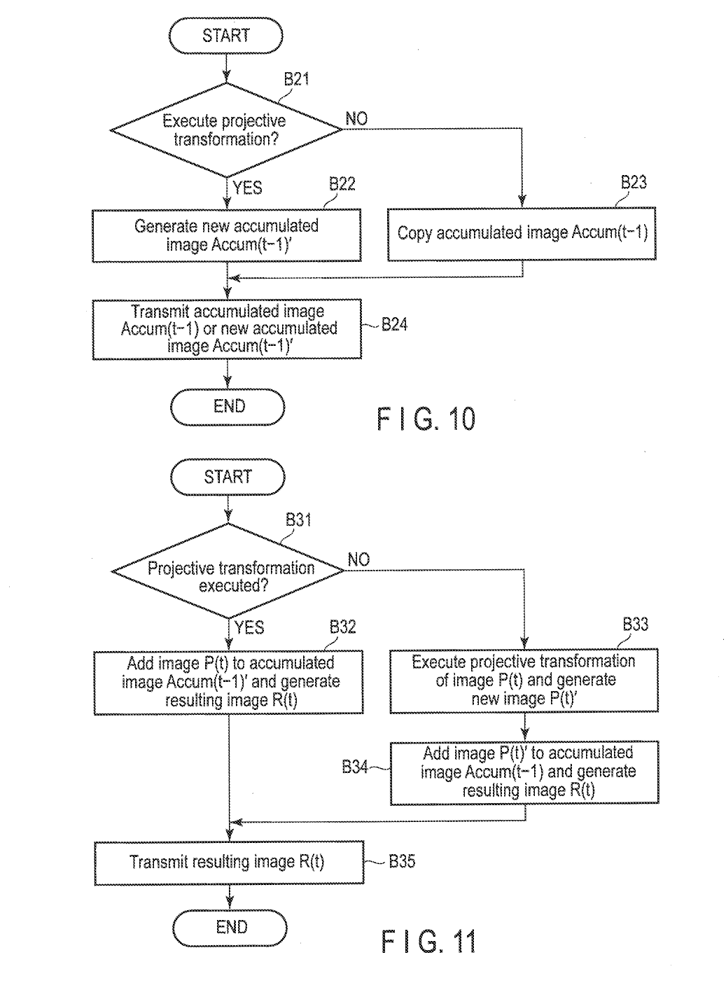

An example of an image deformation process executed by the deformation module 304 is described with reference to a flowchart of FIG. 10.

First, the deformation module 304 determines whether to execute projective transformation (block B21). More specifically, the deformation module 304 compares the display evaluation value Arg(t) of the image P(t) calculated by the display evaluation value calculator 303 with a minimum display evaluation value minArg and determines which of these display evaluation values is smaller. If the deformation module 304 determines that the display evaluation value Arg(t) of the image P(t) is smaller than the minimum display evaluation value minArg, the deformation module 304 determines that projective transformation of the accumulated image Accum(t−1) should be executed. In contrast, if the deformation module 304 determines that the minimum display evaluation value minArg is smaller than the display evaluation value Arg(t) of the image P(t), the deformation module 304 determines that projective transformation of the accumulated image Accum(t−1) should not be executed.

The minimum display evaluation value minArg is the smallest one of display evaluation values of one or more images captured before the image P(t). Then, if the image P(t) is an image first captured in the process of panoramic photography (in other words, the first image), a display evaluation value Arg(t) of the image P(t) is set as the minimum display evaluation value minArg.

The relationship between the display evaluation value Arg(t) and the minimum display evaluation value minArg is hereinafter described in detail. It is assumed that the subject is first photographed from the oblique direction, next from the front, and finally from the oblique direction on the opposite side of the first side. Since there is no minimum display evaluation value to be compared with a display evaluation value of an image first captured (i.e., the first image) at the time the first image is captured, the display evaluation value of the first image is set as the minimum display evaluation value. Since an image captured following the first image (i.e., the second image) is an image obtained by photographing the subject from the front (i.e., slopes of upper and lower sides of the subject in the second image with respect to the horizontal line are small) differently from the first image as described above, a display evaluation value of the second image is smaller than the minimum display evaluation value at this time (in other words, the display evaluation value of the first image). That is, the minimum display evaluation value used in the following process is changed from the display evaluation value of the first image to the display evaluation value of the second image. Since an image captured following the second image (i.e., the third image) is an image obtained by photographing the subject from the oblique direction as described above, a display evaluation value of the third image is greater than the minimum display evaluation value at this time (in other words, the display evaluation value of the second image). That is, the minimum display evaluation value used in the following process is not changed from the display evaluation value of the second image. In this manner, the minimum display evaluation value is compared with a display evaluation value of the newest captured image and arbitrarily updated to a display evaluation value smaller than the minimum display evaluation value at that time.

If the deformation module 304 determines that projective transformation should be executed (YES in block B21), the deformation module 304 executes projective transformation of the accumulated image Accum(t−1) by using the image movement amount M(t) calculated by the image movement amount calculator 302, generates a new accumulated image Accum(t−1)′ (block B22) and then proceeds to block B24 to be described later.

In contrast, if the deformation module 304 determines that projective transformation should not be executed (NO in block B21), the deformation module 304 copies the accumulated image Accum(t−1) (block B23).

Then, the deformation module 304 transmits the new accumulated image Accum(t−1)′ generated in block B22 or the accumulated image Accum(t−1) copied in block B23 to the image stitching module 305 (block B24).

After executing the projective transformation of the accumulated image Accum(t−1), the deformation module 304 attaches notification that the projective transformation has been executed to the new accumulated image Accum(t−1)′ and transmits them to the image stitching module 305.

The process of blocks B21 to B24 is executed every time an image is captured by the camera 109.

The description returns to FIG. 6. If the image stitching module 305 accepts input of the new accumulated image Accum(t−1)′ generated by the deformation module 304, the image stitching module 305 executes processing of adding (stitching) the image P(t) to a certain position in the new accumulated image Accum(t−1)′, more specifically, a relative position obtained based on the image movement amount M(t) calculated by the image movement amount calculator 302.

In contrast, if the image stitching module 305 accepts input of the accumulated image Accum(t−1) copied by the deformation module 304, the image stitching module 305 executes projective transformation of the image P(t) by using the image movement amount M(t) calculated by the image movement amount calculator 302 and generates a new image P(t)′. The image stitching module 305 executes processing of adding (stitching) the new image P(t)′ to a certain position in the accumulated image Accum(t−1), more specifically, a relative position obtained based on the image movement amount M(t) calculated by the image movement amount calculator 302.

An example of an image stitching process executed by the image stitching module 305 is described with reference to a flowchart of FIG. 11.

First, the image stitching module 305 determines whether the deformation module 304 has executed projective transformation of the accumulated image Accum(t−1) (block B31). More specifically, the image stitching module 305 determines that the deformation module 304 has executed projective transformation of the accumulated image Accum(t−1) if the image stitching module 305 accepts the above-described notification from the deformation module 304 together with the new accumulated image Accum(t−1)′. In contrast, the image stitching module 305 determines that the deformation module 304 has not executed projective transformation of the accumulated image Accum(t−1) if the image stitching module 305 accepts input of the image (copied image Accum(t−1)) but the notification is not input.

If the image stitching module 305 determines that projective transformation has been executed (YES in block B31), the image stitching module 305 adds the image P(t) to a certain position in the new accumulated image Accum(t−1)′ generated by the deformation module 304, in other words, a relative position obtained based on the image movement amount M(t), generates a resulting image R(t) (block B32) and then proceeds to block B35 to be described later.

If the image stitching module 305 determines that projective transformation has not been executed (NO in block B31), the image stitching module 305 executes projective transformation of the image P(t) by using the image movement amount M(t) calculated by the image movement amount calculator 302 and generates a new image P(t)′ (block B33).

After generating the new image P(t)′, the image stitching module 305 adds the new image P(t)′ to a certain position in the accumulated image Accum(t−1) copied by the deformation module 304, in other words, a relative position obtained based on the image movement amount M(t), and generates a resulting image R(t) (block B34). Then, the image stitching module 305 transmits the generated resulting image R(t) to the display module 306 (block B35).

The resulting image R(t) is arbitrarily stored in the temporary memory 401 as a group of images captured by the camera 109 by time t, i.e., the accumulated image Accum(t).

The process of blocks B31 to B35 is executed every time an image is captured by the camera 109.

The description returns to FIG. 6. The display module 306 executes processing of displaying the resulting image R(t) generated by the image stitching module 305 on the LCD 17A.

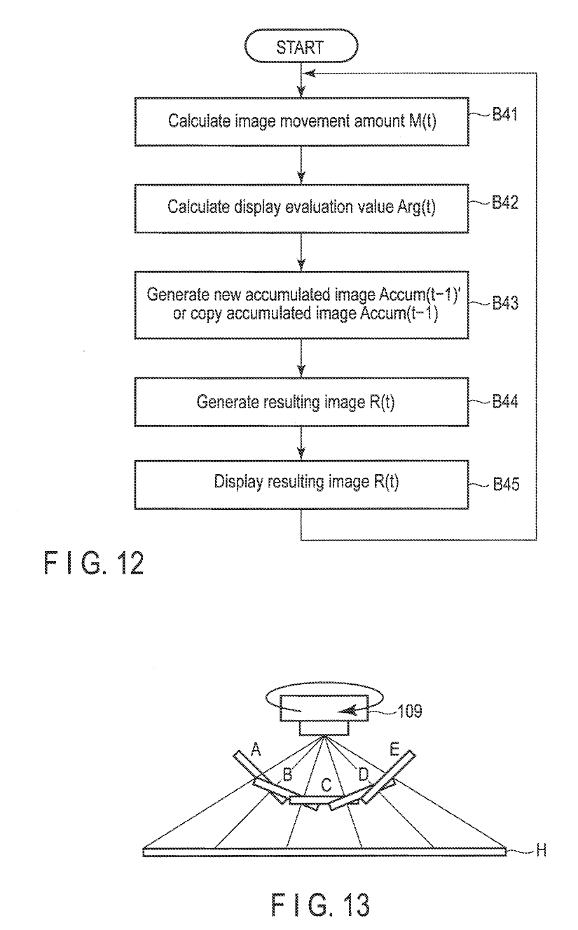

Next, the series of processes executed by the panoramic photography application program 202 configured as described above is briefly described with reference to a flowchart of FIG. 12.

First, if the image movement amount calculator 302 accepts input of an image P(t) captured at time t via the input acceptance module 301, the image movement amount calculator 302 calculates an image movement amount M(t) indicating how far the camera 109 has moved from time t−1 to time t, based on an accumulated image Accum(t−1) stored in the temporary memory 401 and the image P(t) (block B41).

Next, the display evaluation value calculator 303 detects upper and lower borders Ltop and Lbottom of a subject included in the image P(t), calculates slopes Arg(Ltop) and Arg(Lbottom) of the detected upper and lower borders with respect to the horizontal line, and calculates a display evaluation value Arg(t) of the image P(t) (block B42).

Then, the deformation module 304 determines whether to execute projective transformation of the accumulated image Accum(t−1) stored in the temporary memory 401, based on the display evaluation value Arg(t) of the image P(t). If the deformation module 304 determines that projective transformation should be executed, the deformation module 304 executes projective transformation of the accumulated image Accum(t−1) and generates a new accumulated image Accum(t−1)′. If the deformation module 304 determines that projective transformation should not be executed, the deformation module 304 copies the accumulated image Accum(t−1) (block B43).

Next, the image stitching module 305 accepts input of the accumulated image Accum(t−1)′ already subjected to projective transformation, the image stitching module 305 stitches the image P(t) to a relative position in the accumulated image Accum(t−1)′ obtained by the image movement amount M(t) and generates a resulting image R(t). If the image stitching module 305 accepts input of the accumulated image Accum(t−1) not subjected to projective transformation, the image stitching module 305 executes projective transformation of the image P(t) and generates a new image P(t)′. Then, the image stitching module 305 stitches the image P(t)′ to a relative position in the accumulated image Accum(t−1) obtained by the image movement amount M(t) and generates a resulting image R(t) (block B44).

After that, the display module 306 displays the resulting image R(t) on the LCD 17A (block B45). If the camera 109 newly captures an image, the process of blocks B41 to B45 is executed again.

The effect achieved by using the panoramic photography application program 202 is described with reference to FIG. 13 to FIG. 15. It is assumed that an image P(t) has been sequentially captured in each of imaging planes A to E while panning (the camera 109 of) the tablet computer 10, as shown in FIG. 13.

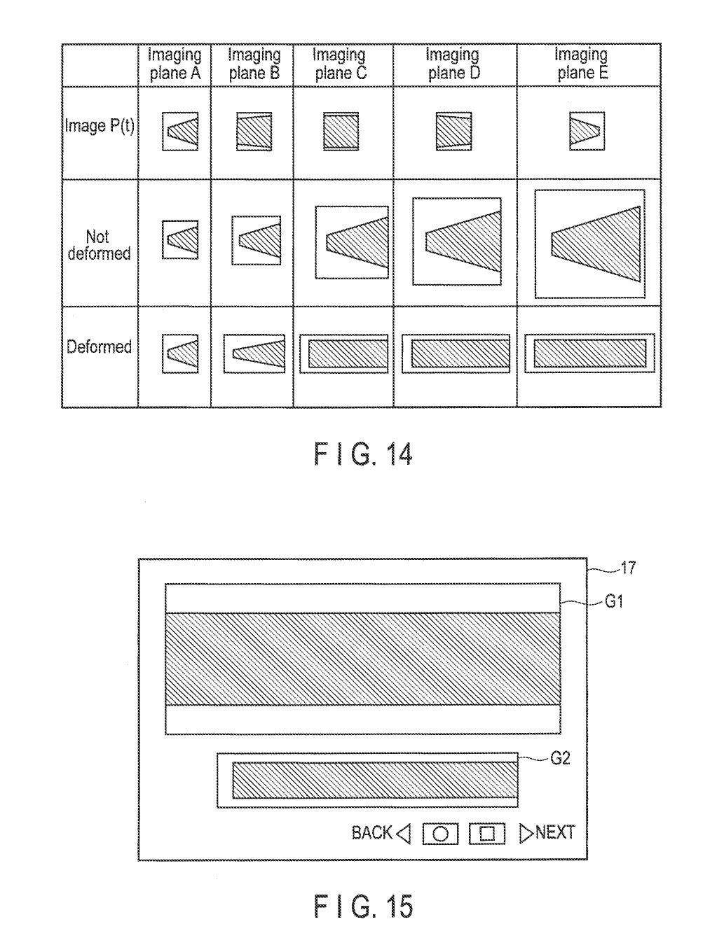

FIG. 14 shows images P(t) captured in imaging planes A to E, respectively, preview display screens in the case of not using the panoramic photography application program 202, and preview display screens in the case of using the panoramic photography application program 202, which are associated with each other.

Since an image P(t) captured in an imaging plane A is an image captured while largely panning the camera 109 with respect to the subject H, upper and lower borders of the subject are largely sloped in this image. Since an image P(t) captured in an imaging plane B is an image captured while slightly panning the camera 109 with respect to the subject H, upper and lower borders of the subject are slightly sloped in this image. Since an image P(t) captured in an imaging plane C is an image captured in front of the subject H, upper and lower borders of the subject are not sloped but parallel to the horizontal line in this image. Since an image P(t) captured in an imaging plane D is an image captured while slightly panning the camera 109 with respect to the subject H similarly to the image captured in imaging plane B, upper and lower borders of the subject are slightly sloped in this image. Since an image P(t) captured in an imaging plane E is an image captured while largely panning the camera 109 with respect to the subject H similarly to the image captured in imaging plane A, upper and lower borders of the subject are largely sloped in this image.

In the case of not using the panoramic photography application program 202, the images P(t) captured in imaging planes A to E are directly stitched to one another. Since the shape of the image P(t) first captured is a trapezoid, a resulting image R(t) is also a trapezoidal image as shown in FIG. 14. According to this, the resulting image R(t) is largely different from each of the images P(t) captured in imaging planes A to E, which causes a problem that the user cannot easily understand how far the subject has been photographed and whether enough images to generate a panoramic image have been captured.

In contrast, in the case of using the panoramic photography application program 202, the images P(t) captured in imaging planes A to E (or an accumulated image Accum(t−1)) are stitched to one another after being deformed in the above-described method. Therefore, the resulting image R(t) is a trapezoidal image when capturing images in imaging planes A and B, and is a rectangular image when capturing images in imaging planes C, D and E. More specifically, when capturing an image in imaging plane A, the image captured in imaging plane A is displayed for preview without any change in slopes. When capturing an image in imaging plane B, slopes of the upper and lower borders of the subject with respect to the horizontal line in the image captured in imaging plane B are adopted. That is, an image obtained by stitching the image captured in imaging plane B to the image captured in imaging plane A and deformed to fit the slopes in the image captured in imaging plane B is displayed for preview. When capturing an image in imaging plane C or the following planes, slopes of the upper and lower borders of the subject with respect to the horizontal line in the image captured in imaging plane C are adopted since these slopes are the most similar to the horizontal line. For example, an image obtained by stitching the above-described stitched image to the image captured in imaging plane C, an image obtained by stitching an image including the image captured in imaging plane C (i.e., an image obtained by stitching the images captured in imaging planes A to C) to an image captured in imaging plane D and deformed to fit the slopes of the image including the image captured in imaging plane C or the like is displayed for preview. According to this, the resulting image R(t) displayed when capturing images in imaging planes A and B follows the shape of the images captured in imaging planes A and B. Therefore, the user can easily understand how far the subject has been photographed. In addition, since the result image R(t) has a rectangular shape when capturing images in imaging planes C and the following planes, the user can easily understand a photographable range. That is, the user can easily understand the photographable range, i.e., understand whether enough images to generate a panoramic image have been captured.

FIG. 15 shows an example of a screen of the tablet computer 10 including the panoramic photography application program 202 displayed during the process for panoramic photography. In FIG. 15, a photography screen G1 is provided on the upper side of the screen and a preview display screen G2 is provided on the lower side of the screen. Video currently input to the camera is displayed on the photography screen G1 as, for example, a moving image. When the moving image is displayed on the photography screen G1, the tablet computer 10 captures still images at predetermined intervals and executes the above-described process for stitching still images every time a still image is captured. The newest still image of the still images captured at predetermined intervals may be displayed on the photography screen G1. A stitched still image or the first unstitched still image is displayed on the preview display screen G2. According to this, the user can perform panoramic photography while arbitrarily checking the resulting image R(t) displayed on the preview display screen G2. In FIG. 15, the photography screen G1 is provided on the upper side of the screen and the preview display screen G2 is provided on the lower side of the screen. However, the arrangement of the photography screen G1 and the preview display screen G2 is not limited to this. The photography screen G1 and the preview display screen G2 may be allocated in arbitrary positions on the display 17.

In the present embodiment, the display evaluation value Arg(t) is a slope of the upper or lower border of the subject with respect to the horizontal line, and which of an image corresponding to the display evaluation value Arg(t) and an image corresponding to the minimum display evaluation value minArg should be subjected to projective transformation is determined based on whether the display evaluation value Arg(t) is smaller than the minimum display evaluation value minArg. However, the method for determining an image to be subjected to projective transformation is not limited to this.

For example, the following method may be used. First, upper and lower borders of a subject included in each of two images (an image P(t) and an accumulated image Accum(t−1)) are detected. The parallelism of the detected upper and lower borders of the subject included in one image is compared with the parallelism of the detected upper and lower borders of the subject included in the other image. If the one image has upper and lower borders more similar to parallel lines, projective transformation of the other image is determined to be executed to fit the other image to the one image. The method is described below in detail. It is hereinafter assumed that the subject is first photographed from the oblique direction, next from the front, and finally from the oblique direction on the opposite side of the first side. Since there is no image to be compared with a first captured image (the first image) when the first image is captured, the first image is selected as an image to be compared with an image which will be next captured at this time. If the second image is captured following the first image, upper and lower borders of the subject included in each of the first and second images are detected. Which of the images should be subjected to projective transformation is determined based on which of the images has upper and lower borders more similar to parallel lines. In this case, since the first image is obtained by photographing the subject from the oblique direction and the second image is obtained by photographing the subject from the front, upper and lower borders of the subject included in the second image are more similar to parallel lines than upper and lower borders of the subject included in the first image. Therefore, projective transformation of the first image is determined to be executed. As an image to be compared with an image which will be captured next, the second image (more specifically, an image obtained by stitching the second image to the first image subjected to projective transformation to fit the second image) including the upper and lower borders the most similar to parallel lines is selected. If the third image is captured following the second image, upper and lower borders of the subject included in each of the second and third images are detected. Which of the images should be subjected to projective transformation is determined based on which of the images has upper and lower borders more similar to parallel lines. In this case, since the second image is obtained by photographing the subject from the front and the third image is obtained by photographing the subject from the oblique direction, the upper and lower borders of the subject included in the second image are more similar to parallel lines than upper and lower borders of the subject included in the third image. Therefore, projective transformation of the third image is determined to be executed. An image to be subjected to projective transformation may be determined in the above method.

The panoramic photography application program 202 of the present embodiment may further have a function of notifying the user that the subject is not included in the photographable range of the camera 109 (i.e., the upper and lower border of the subject cannot be detected) if the upper and lower border of the subject cannot be detected while forwarding panoramic photography.

According to the above-described embodiment, the tablet computer 10 includes the panoramic photography application 202 described above. Therefore, the tablet computer 10 can provide the user with an environment where the user can easily understand how far the subject has been photographed and whether enough images to generate a panoramic image have been captured in the process of panoramic photography.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a memory;
circuitry coupled to the memory and configured to:
acquire a first image and a second image partly overlapping each other;
correct the first image if a slope of a subject in the second image is more similar to a predetermined value than a slope of the subject in the first image, a slope of the subject in the corrected first image being equal to the slope of the object in the second image;
generate a third image by stitching the corrected first image to the second image; and
display the third image on a display.

2. The electronic device of claim 1, wherein
the subject is a rectangular object.

3. The electronic device of claim 2, wherein
the circuitry is configured to correct the first image if a slope of an upper side of the rectangular object with respect to a horizontal line in the second image is more similar to the horizontal line than a slope of an upper side of the rectangular object with respect to the horizontal line in the first image.

4. The electronic device of claim 2, wherein
the circuitry is configured to correct the first image if a slope of a lower side of the rectangular object with respect to a horizontal line in the second image is more similar to the horizontal line than a slope of a lower side of the rectangular object with respect to the horizontal line in the first image.

5. The electronic device of claim 1, wherein
the circuitry is configured to acquire the third image and acquire a fourth image captured after the third image is generated,
the circuitry is configured to correct the third image if a slope of the subject in the fourth image is more similar to the predetermined value than a slope of the subject in the third image, and
a slope of the subject in the corrected third image is equal to the slope of the subject in the fourth image.

6. The electronic device of claim 1, wherein
the circuitry is configured to generate the third image by stitching the first and second images based on an image movement amount indicating how the first and second images overlap each other.

7. The electronic device of claim 1, wherein
the circuitry is configured to correct the first image if (a) the slope of the subject in the first and second images is not horizontal and (b) the slope of the subject in the second image is more similar to the predetermined value than the slope of the subject in the first image, and
a slope of the subject in the corrected first image is equal to the slope of the subject in the second image and is not horizontal.

8. A method comprising:
acquiring a first image and a second image partly overlapping each other;
correcting the first image if a slope of a subject in the second image is more similar to a predetermined value than a slope of the subject in the first image, a slope of the subject in the corrected the first image being equal to the slope of the object in the second image;
generating a third image by stitching the corrected the first image to the second images; and
displaying the third image on a display.

9. The method of claim 8, wherein
the subject is a rectangular object.

10. The method of claim 9, wherein
the correcting comprises correcting the first image if a slope of an upper side of the rectangular object with respect to a horizontal line in the second image is more similar to the horizontal line than a slope of an upper side of the rectangular object with respect to the horizontal line in the first image.

11. The method of claim 9, wherein
the correcting comprises correcting the first image if a slope of a lower side of the rectangular object with respect to a horizontal line in the second image is more similar to the horizontal line than a slope of a lower side of the rectangular object with respect to the horizontal line in the first image.

12. The method of claim 8, wherein
the acquiring comprises acquiring the third image and acquiring a forth image captured after the third image is generated,
the correcting comprises correcting the third image if a slope of the subject in the forth image is more similar to the predetermined value than a slope of the subject in the third image, and
a slope of the subject in the corrected third image is equal to the slope of the subject in the forth image.

13. The method of claim 8, wherein
the generating comprises generating the third image by stitching the first and second images based on an image movement amount indicating how the first and second images overlap each other.

14. The method of claim 8, wherein
the correcting comprises correcting the first image if (a) the slope of the subject in the first and second images is not horizontal and (b) the slope of the subject in the second image is more similar to the predetermined value than the slope of the subject in the first image, and
a slope of the subject in the corrected first image is equal to the slope of the subject in the second image and is not horizontal.
